(19) United States
(12) Patent Application Publication
(10) Pub. No.: US 2012/0255446 A1
(43) Pub. Date: Oct. 11, 2012

(54) OXYGEN GENERATOR

(75) Inventors: Johannes Eickhoff, Ludwigsburg (DE); Saad Abusamra, Weinsberg (DE)

(73) Assignee: Duerr Technik GmbH & Co. KG, Bietigheim-Bissingen (DE)

(21) Appl. No.: 13/206,764

(22) Filed: Aug. 10, 2011

(30) Foreign Application Priority Data
Apr. 5, 2011 (DE) 10 2011 016 157.0

(51) Int. Cl. B01D 53/04

(52) U.S. Cl. 96/111; 96/121; 96/113; 96/109

(57) ABSTRACT

An oxygen generator (10) similar to a suitcase includes a compressor unit (24) and an oxygen separating unit (38). These two units have, together with auxiliary components, substantially the same axial dimensions as one another and are arranged next to one another in the interior of a suitcase-shaped housing (68).

The invention relates to an oxygen generator according to the precharacterising clause of claim 1.

Oxygen generators of this kind are known as a fixed unit, for example to provide air enriched with oxygen for medical purposes.

The present invention is to provide new applications for oxygen generators of this kind in mobile use. These applications relate to supplying persons with respiratory air containing sufficient oxygen at high altitude, in particular in craft which operate at high altitude. These may in particular be aircraft which are not provided with a respiratory air supply, or indeed motor vehicles which are used at high altitude.

This object is achieved in that the invention provides an oxygen generator according to claim 1, which is characterised by a compact structure and can thus be placed in an unpressurised craft or vehicle which is not equipped with a respiratory air supply, as a portable unit.

By means of the oxygen generator according to the invention, the occupants of a craft operating at high altitude may be adequately supplied with respiratory air containing sufficient oxygen even over long periods, whereas a supply from oxygen cylinders is only possible for a limited period (typically around two hours).

Since an oxygen generator according to the invention is of compact dimensions, it may also be installed in craft or vehicles in fixed manner if appropriate, even if the latter are not in themselves designed with a space for installing an oxygen generator. Even if a space for installation is provided in the design, it need only be small, with the result that only minor amendments have to be carried out on known, previously unpressurised designs of craft or vehicles which have only a negligible effect on the driving and flying properties, with the result that the risks associated with provision are very small and approval of the craft or vehicle can be retained with an additional inspection of limited scope.

Advantageous further developments of the invention are specified in the subclaims.

The further development of the invention according to claim 2 is advantageous in respect of the particularly compact dimensions of the oxygen generator.

The further development according to claim 3 also serves this purpose.

A compressor of the structure specified in claim 4 has a large overall operating chamber with compact dimensions.

According to claim 5, the compressor serves to compress the intake air to a high degree.

The further development of the invention according to

claim 6 is advantageous in respect of simple transfer of the oxygen generator to a point of use.

Here, an oxygen generator according to claim 7 can be securely fixed to a craft or vehicle wall at the location of use in a simple manner.

The further development of the invention according to claim 8 is advantageous in respect of an energy supply to the oxygen generator from the onboard power supply of a craft or vehicle.

In this case, the further development of the invention according to claim 9 has the advantage that the rate of oxygen production of the oxygen generator can be controlled electrically in a simple manner, namely by way of the electrical switching of the direct-current motor.

In the case of an oxygen generator according to claim 10, the rate of oxygen production is controlled automatically in dependence on the respective ambient conditions and/or conditions required.

In this case, in an oxygen generator according to claim 11, it is ensured that the drive motor of the compressor does not overload the power supply that feeds the compressor. Moreover, in this way the possibility of excessive heating of the oxygen generator is eliminated at the same time.

Typical separating units for separating an incoming air flow into a first oxygen-rich outgoing flow and a second nitrogen-rich outgoing flow include adsorbent beds which are moved by an electric drive from a charging position into a first pressure-relief position and then into a second pressure-relief position. The further development according to claim 12 ensures that this movement is also controlled in dependence on the ambient conditions or the requirement for oxygen.

In the case of an oxygen generator according to claim 13, the possibility that moisture arising as air is compressed reaches the separating unit by any more than a negligible extent is prevented.

The further development of the invention according to

claim 14 is advantageous in respect of the cleanliness of the oxygen-enriched air generated, and in respect of keeping dirt away from the separating unit.

Similarly, the further development of the invention according to claim 15 serves to generate clean oxygen-enriched air.

The further development of the invention according to claim 16 enables the output rate of the oxygen-enriched air to be limited.

Similarly, adjusting the output flow of respiratory air according to claim 17 makes it possible to take account of changing ambient conditions automatically.

An oxygen generator as specified in claim 18 may be rapidly connected in terms of flow to an installation at the point of use and where necessary also be disconnected from this installation again.

The invention will be explained in more detail below by means of an exemplary embodiment and with reference to the drawing, in which:

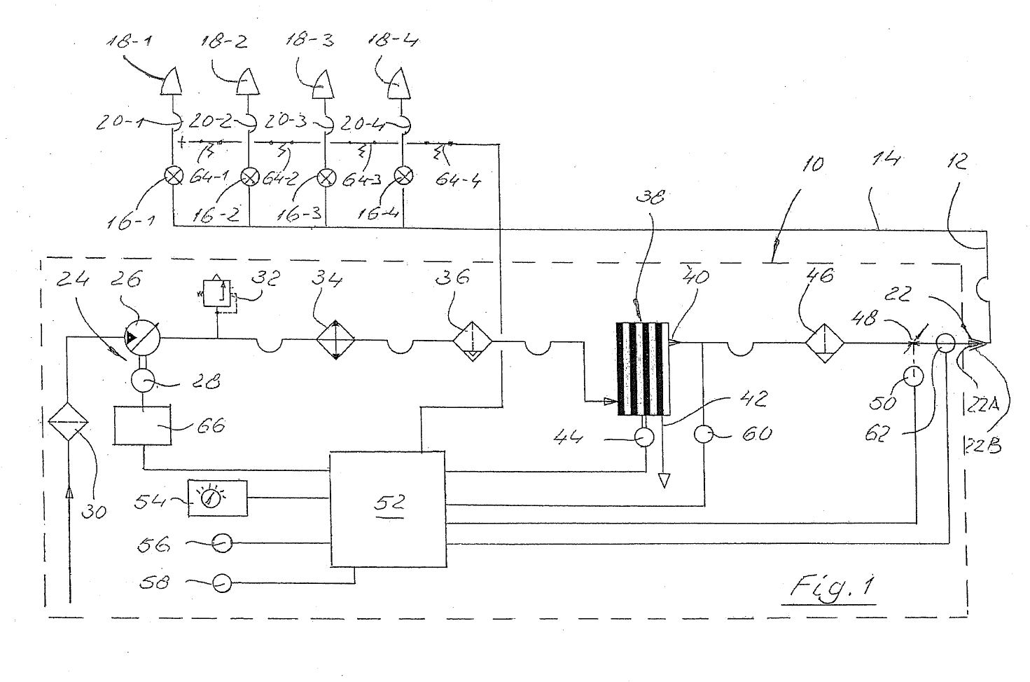

FIG. 1 shows a circuit diagram of a system for supplying the occupants of an unpressurised, relatively small aircraft with oxygen-enriched respiratory air;

FIG. 2 shows a perspective view of a portable oxygen generator which is part of the system shown in FIG. 1, seen from front left;

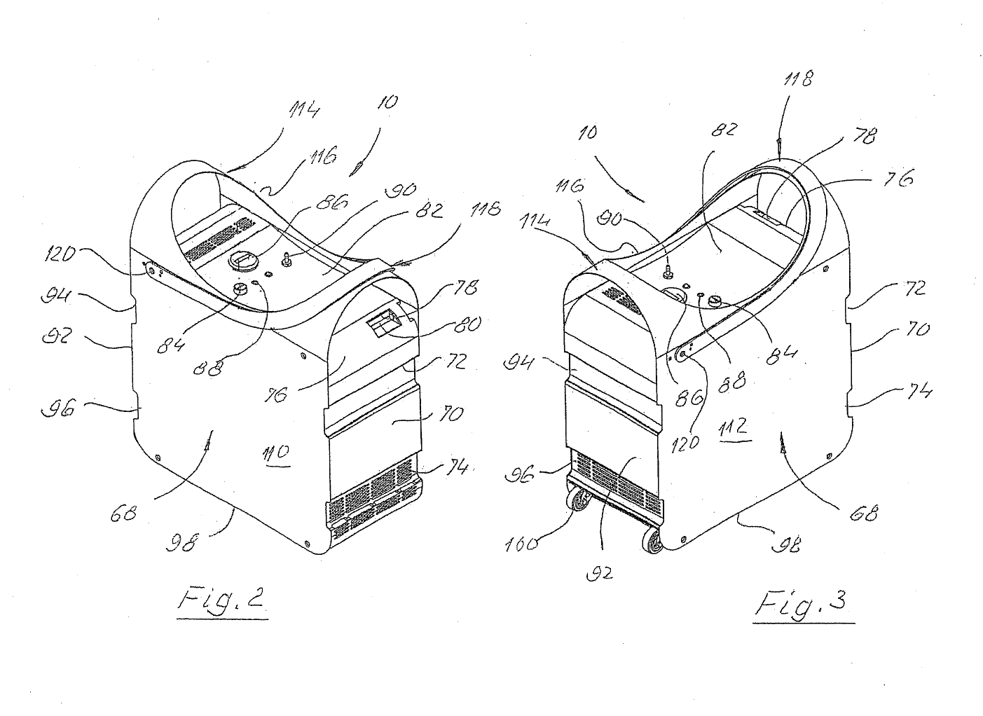

FIG. 3 shows a view of the oxygen generator according to FIG. 2, seen from rear right;

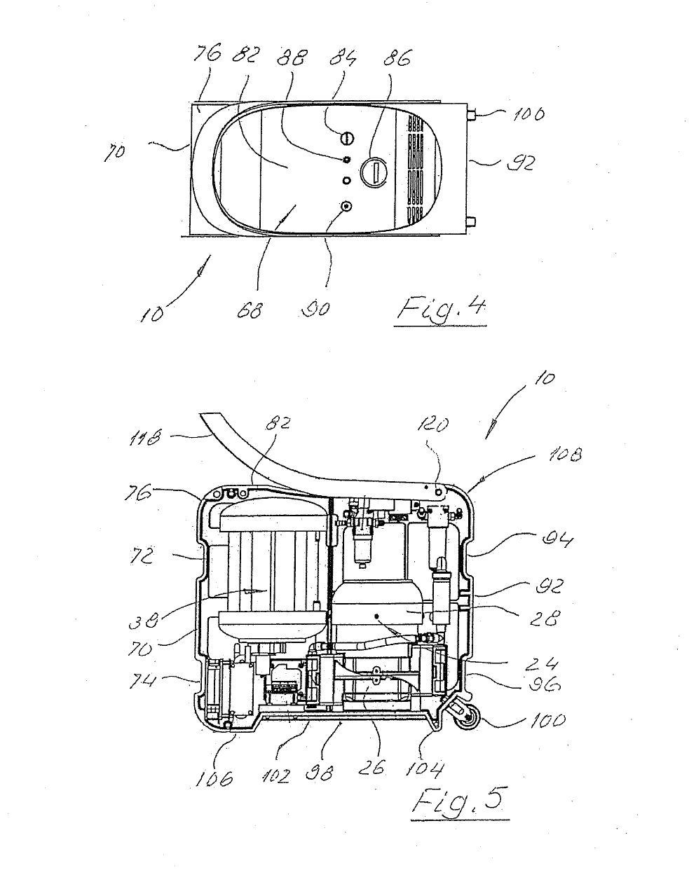

FIG. 4 shows a top view of the oxygen generator according to FIGS. 2 and 3;

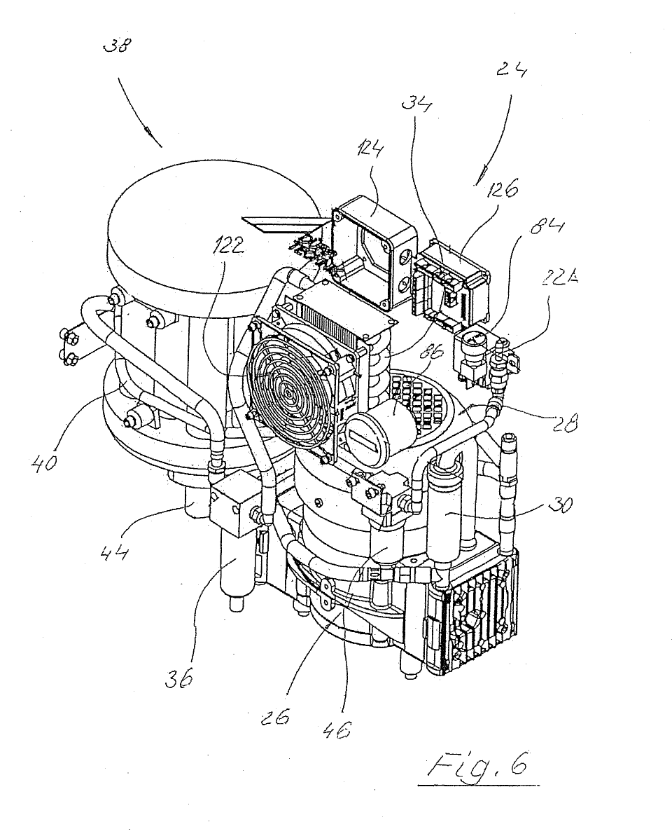

FIG. 5 shows a lateral view of the oxygen generator according to FIGS. 2 to 4, in which the right-hand housing wall has been removed to show the spatial arrangement of the functional units of the oxygen generator; and

FIG. 6 shows a perspective view of the functional units of the oxygen generator.

In FIG. 1, 10 designates overall an oxygen generator which is connected by way of a flexible line section 12 to a distributor line 14 which is laid in the passenger cabin of a relatively small aircraft not provided with pressure compensation (that is, unpressurised). Connected to the distributor line 14 by way of rotary slide valves 16-1, 16-2, 16-3 and 16-4 are respiratory masks 18-1, 18-2, 18-3, 18-4, in each case by way of a flexible line section 20-1, 20-2, 20-3 and 20-4.

The oxygen generator 10 is connected to the line section 12 by way of a quick-connect coupling 22 which is illustrated schematically and includes coupling parts 22A and 22B.

The oxygen generator 10 includes a compressor unit 24 which includes a compressor 26 and an electrically switched direct-current drive motor 28.

The compressor 26, whereof the structure will be described specifically below, takes in air from the interior of the passenger cabin by way of an input filter 30. The output of the compressor unit 26 is connected to an overpressure valve 32 and a radiator 34. The radiator 34 is connected by way of a water separator 36, which includes a filter, to the mixing inlet of a separating unit 38. The latter outputs oxygen-enriched air at a first outlet 40 and, correspondingly, nitrogen-enriched air at a second outlet 42.

The separating unit 38 is an adsorption separating unit which makes use of the fact that oxygen gas and nitrogen gas adhere to certain adsorbent materials to different extents. It contains adsorption chambers which are typically closed and in which adsorbent material having a large specific surface area is located. For the present description, it is assumed that the adsorbent material binds oxygen molecules more strongly than it does nitrogen molecules. If air acts on a closed volume of adsorbent material and the closed adsorption chamber is moved from an inlet station of the separating unit to a first outlet station and then to a second outlet station, then nitrogen-enriched air will be obtained at the first outlet station and oxygen-enriched air will be obtained at the second outlet station.

The degree of separation which is achieved here depends on the type of adsorbent material used, the pressure prevailing in the adsorption chamber and the speed at which the adsorption chamber is moved from the inlet station by way of the first outlet station to the second outlet station.

For moving the adsorption chamber, the separating unit 38 includes an electronic geared motor 44.

The nitrogen-enriched gas that is output at the outlet of the separating unit 38 is output into the passenger cabin and removed from there by suction, since unpressurised aircraft typically have a venting opening at the rear end of the passenger cabin which is connected to the atmosphere surrounding the aircraft. This venting opening removes by suction portions of air in the passenger cabin using the Venturi effect, on an ongoing basis. A corresponding quantity of unconsumed air replaces it by flowing into the interior of the passenger cabin from the outside, through regions of the passenger cabin which are not closed in light-tight manner, in particular door openings and so on.

The oxygen-enriched portion of the air is fed through a water separator 46, including a filter, and a throttle valve 48 to the quick-connect coupling 22.

The throttle valve 48 can be adjusted during flight by a servo motor 50.

A control unit 52 ensures that the various functional parts of the oxygen generator 10 that are shown in FIG. 1 are adjusted to work together.

This control unit 52 is connected on the inlet side to a selector unit 54 at which the pilot of the aircraft pre-selects the desired rate of oxygen production, depending on the anticipated flight conditions and the number of passengers.

The control unit 52 is further connected to a pressure meter 56 which measures the air pressure. Instead of this and/or in addition, the control unit 52 may be connected to further sensors which provide the signals characteristic of the current flight conditions. These may for example be an altimeter of the aircraft, which is already provided for navigation purposes, or indeed a GPS unit which outputs a signal corresponding to the current altitude of flight.

The control unit 52 is further connected to a situation sensor 58 which outputs a signal if the behaviour of the pilot or another passenger is out of the ordinary. Sensors of this kind respond for example to pupil movements of the person being monitored, to atypical control commands from the person (for example deviations from the course and abrupt corrections to the course).

The control unit 52 also receives, as further input signals, the output signal of a concentration sensor 60 which determines the concentration of oxygen in the oxygen output line of the separating unit 38. The control unit 52 is informed by way of a throughput sensor 62 upstream of the quick-connect coupling 22 of the quantity of oxygen-enriched gas currently being output to the consumers.

Further, the control unit 52 is connected to a line of switches which includes buttons 64-1, 64-2, 64-3 and 64-4, connected in series and normally closed.

Roughly speaking, the control unit 52 operates such that it normally generates and outputs oxygen in dependence on the position of the selector unit 54, but output is increased if the altitude of flight increases, if situations occur in the behaviour of the pilot or a passenger, or on request by the pilot or a passenger.

To perform this, the control unit 52 changes the supply from the drive motor 28, increasing the speed thereof by increasing the frequency of the supply current. In this connection, the supply current to the drive motor 28 is always kept below a maximum current which it is permitted for the onboard power supply of the aircraft to output without having an adverse effect on the primary loads on the onboard power supply (ignition, navigation, radio traffic etc.), by a current limiter 66.

The control unit 52 also controls the geared motor 44 of the separating unit 38 accordingly.

In addition, the control unit 52 can adjust the throttle valve 48 by acting on the servo motor 50.

The functional components of the oxygen generator 10 which are shown in FIG. 1 are all accommodated in a suitcase-like housing 68 which will now be described in more detail with reference to FIGS. 2 to 5.

The housing 68 has a front wall 70 which in the upper half is constructed with a broad groove 72 and in its lower portion is provided with a further broad groove 74 whereof the base takes the form of a slotted grating.

In an upper, curved transition portion 76 of the housing 68 there is a window 78 which receives a display unit 80 at which the current operating condition of the oxygen generator 10 can be read, in particular indicating disruptions to operation.

An upper cover wall 82 bears a main switch 84, an operating hours counter 86, an indicator lamp 88 and a selector member 90.

A rear wall 92 of the housing 68 has an upper broad groove 94 and a lower broad groove 96 which are substantially flush with the grooves 72, 74 in the front wall 70.

The base of the groove 96 once again takes the form of a slotted grating.

Rollers 100 are mounted in a recessed corner portion, between the rear wall 92 and a base wall 98 of the housing.

The base wall 98 has a narrowed portion 102 which extends over much of its length and is delimited by raised, rib-like portions 104, 106 which form feet for the housing 68 to stand on.

The walls 70, 82, 92 and 98 are connected to one another in a single piece. They may for example be formed by a one-piece cast part 108.

The side faces of the housing 68 are formed by sheet-metal side walls 110, 112 which are screwed to the cast part 108. The side walls 110, 112 have recesses on their vertical edges which form smooth continuations of the grooves 72, 74 and 94, 96.

Screwed to the upper side of the housing unit which is formed in this way is, in addition, a roof part 114 which is semi-cylindrical in shape. This semi-cylindrical channel has in its upper side a large oval opening 116 through which the cover wall 82 remains visible and accessible. In this way, the two ends of the roof part 114 form semi-circular handles by means of which the oxygen generator 10 can be lifted.

Over the roof part 114 there lies a bracket part 118 which is connected to the housing 68 in articulated manner by bearing screws 120 and has a contour such that it follows the edge of the opening 116 and, in a condition shown in FIGS. 2 and 3, in which it is folded down, snugly follows the shape of the roof part 114.

The bracket part 118 may be pivoted anticlockwise, as seen in FIG. 2, and in that case forms a handle by means of which the oxygen generator 10 may be pushed or pulled. In this connection, the path of pivoting of the bracket part 114 may be delimited by a stop such that a moment of tilting may be exerted on the housing 68, and as a result of this the base portions 104, 106 come free of an installation surface and the housing 68 can then be moved on the installation surface by means of the rollers 100.

The grooves 72, 74, 94 and 96 may be used to latch the oxygen generator 10 to corresponding holding parts which are mounted on a wall of the passenger cabin. It will be appreciated that in this connection the holding parts of the passenger cabin which cooperate with the grooves 74 and 96 are constructed such that the slotted gratings located there, which serve to connect the interior of the housing 68 to the surroundings, are not closed off by more than a negligible amount.

FIGS. 5 and 6 illustrate how the functional components of the oxygen generator 10 are accommodated in a substantially cubic space which is of small dimensions in the direction perpendicular to the plane of the drawing in FIG. 5, by comparison with the other main dimensions.

Two sub-units are fitted into this flat cube next to one another (to left and right as seen in FIG. 5), these sub-units being formed by the separating unit 38 and the geared motor 44 associated therewith, on the one hand, and including the compressor unit 24, the radiator 34, the water separator 36, the water separator 46 and the throttle valve 48, on the other.

Thus, these two sub-units have approximately the same dimensions in the vertical direction, as seen in FIG. 5, and the direction perpendicular to the plane of the drawing in FIG. 5.

As can be seen in particular from FIG. 6, the compressor 26 is an opposing cylinder unit having two compressor stages provided in a diametrically opposed arrangement. Here, a heat exchanger is set on the end side of the cylinder which is on the right in FIG. 6.

A ventilator 122 is provided for the radiator 34, which is arranged above the drive motor 28, and this ventilator 122 is also supplied from the onboard power supply by way of the control unit 52.

Two housing parts 124, 126, which are injection moulded plastics parts, receive sub-units of the control unit 52.

The drive motor 28 is an electronically switched, lightweight direct-current motor. Its speed may be controlled by the control unit 52, as a result of which the operating frequency of the compressor 24 may also be controlled.

The electric motors 42, 44, 50 are supplied from the onboard power supply of the aircraft, typically a 27-volt direct-current power supply. The same applies to the electronic components of the oxygen generator. Here, the drive motor 28 driving the compressor 26 has the greatest power requirement. The current limiter 66 ensures that the drive motor 28 cannot put at risk the supply of power to other important consumers of the onboard power supply by drawing a large current.

In practice, an oxygen generator 10 which is sufficient to supply oxygen to four persons at an altitude of from 4 to 6 km can be accommodated in a housing having dimensions of around 62×56×27 cm.

In this connection, the overall weight of the device is approximately 28 kg. When operated from a 27-volt direct-current onboard power supply, the oxygen generator draws around 25 A and generates around 4 litres of oxygen per minute.

From the data above it can be seen that the oxygen generator can still be carried and installed by one person, and can also be wheeled over longer distances on the rollers 100.

1. An oxygen generator having a compressor unit and a separating unit which separates compressed air into a first oxygen-rich portion and a second nitrogen-rich portion,
characterised in that
the compressor unit and the separating unit and any auxiliary components are arranged in a portable structure having a simple geometry.

2. An oxygen generator according to claim 1, characterised in that the compressor unit and the separating unit are arranged next to one another.

3. An oxygen generator according to claim 2, characterised in that the separating unit on the one hand and the compressor unit, together with auxiliary components, have substantially the same axial dimensions.

4. An oxygen generator according to claim 1, characterised in that the compressor unit includes a piston compressor which has two piston-and-cylinder units which are provided in a diametrically opposed arrangement.

5. An oxygen generator according to claim 4, characterised in that the piston-and-cylinder units are connected in series in respect of flow.

6. An oxygen generator according to claim 1, characterised in that the portable structure takes a form similar to a suitcase.

7. An oxygen generator according to claim 1, characterised in that the portable structure is provided with connection means which can cooperate with counter-connection means borne by a wall of a passenger cabin.

8. An oxygen generator according to claim 1, characterised in that the compressor unit includes a direct-current drive motor which is optionally supplied from a direct-current onboard power supply of the craft or vehicle.

9. An oxygen generator according to claim 8, characterised in that the direct-current drive motor is an electronically switched motor.

10. An oxygen generator according to claim 8, characterised in that the speed of the direct-current drive motor is controlled in dependence on the output signal of at least one sensor selected from the group consisting of: air pressure sensor, altitude sensor, oxygen concentration sensor, situation sensor, flight monitoring sensor.

11. An oxygen generator according to claim 8, characterised in that it includes a current limiter for the direct-current drive motor.

12. An oxygen generator according to claim 1, in which the separating unit includes a bed drive motor, characterised in that the bed drive motor is a direct-current motor, and in that the speed of the bed drive motor is controlled in dependence on the output signal of a sensor selected from the group consisting of: air pressure sensor, altitude sensor, oxygen concentration sensor, situation sensor, flight monitoring sensor.

13. An oxygen generator according to claim 1, characterised by a condenser which is connected between the output of the compressor unit and the inlet of the separating unit.

14. An oxygen generator according to claim 1, characterised by a first filter which is connected upstream of the inlet of the separating unit.

15. An oxygen generator according to claim 1, characterised by a fine filter which is connected downstream of the outlet of the separating unit.

16. An oxygen generator according to claim 1, characterised by a current-limiting throttle valve on the outlet side.

17. An oxygen generator according to claim 16, characterised in that the nozzle of the throttle valve may be adjusted by a servo motor which operates in dependence on the output signal of a sensor selected from the group consisting of: air pressure sensor, altitude sensor, oxygen concentration sensor, situation sensor, flight monitoring sensor.

18. An oxygen generator according to claim 1, characterised in that a coupling part is provided at its outlet.
